(19) United States
(12) Patent Application Publication
(10) Pub. No.: US 2016/0124258 A1
(43) Pub. Date: May 5, 2016

(54) SINGLE-SUBSTRATE DISPLAY DEVICE AND MANUFACTURING METHOD THEREOF

(71) Applicant: Samsung Display Co., Ltd., Yongin-City (KR)

(72) Inventors: Yang-Ho JUNG, Seoul (KR); Hoon KANG, Suwon-si (KR); Chul Won PARK, Gwangmyeong-si (KR); Koichi SUGITANI, Hwaseong-si (KR); Jin Ho JU, Seoul (KR)

(21) Appl. No.: 14/710,278

(22) Filed: May 12, 2015

(30) Foreign Application Priority Data
Oct. 30, 2014 (KR) 10-2014-0149353

(51) Int. Cl. G02F 1/1368; G02F 1/1337; G02F 1/1333

(52) U.S. Cl. CPC G02F 1/1368; G02F 1/133377; G02F 1/1337; G02F 1/133345

(57) ABSTRACT

A display device with a simplified manufacturing method is presented. The display device includes: a substrate; a thin film transistor formed on the substrate; a pixel electrode connected to the thin film transistor; a roof layer formed to be separated from the pixel electrode via a plurality of microcavities on the pixel electrode; a liquid crystal layer filling the microcavities; and an encapsulation layer formed on the roof layer and sealing the microcavities, wherein the roof layer includes a partition positioned between the plurality of microcavities, and the partition has a width decreases with increasing distance from the substrate.

### CROSS-REFERENCE TO RELATED APPLICATION

This application claims priority to and the benefit of Korean Patent Application No. 10-2014-0149353 filed in the Korean Intellectual Property Office on Oct. 30, 2014, the entire contents of which are incorporated herein by reference.

### BACKGROUND

(a) Technical Field

The present invention relates to a display device and a manufacturing method.

(b) Description of the Related Art

Liquid crystal displays are currently one of the most widely used types of flat panel displays. A liquid crystal display typically includes two display panels on which field generating electrodes such as a pixel electrode and a common electrode are formed and a liquid crystal layer that is disposed therebetween. A liquid crystal display shows an image by applying a voltage to a field generating electrode to generate an electric field on the liquid crystal layer, which determines alignment of liquid crystal molecules of the liquid crystal layer and controls polarization of incident light.

The two display panels forming the liquid crystal display may be a thin film transistor array panel and an opposing display panel. In the thin film transistor array panel, a gate line transmitting a gate signal and a data line transmitting a data signal are formed to extend perpendicularly to each other. A thin film transistor is connected to the gate line and the data line, and a pixel electrode is connected to the thin film transistor. The opposing display panel may include a light blocking member, a color filter, a common electrode, etc. In some cases, however, the light blocking member, the color filter, and the common electrode may be formed in the thin film transistor array panel.

A typical liquid crystal display includes two sheets of substrates, and various constituent elements are formed on the two sheets of substrates. As a result, a liquid crystal display device is heavy and thick, costly, and has a long processing time.

The above information disclosed in this Background section is only for enhancement of understanding of the background of the invention and therefore it may contain information that does not form the prior art that is already known in this country to a person of ordinary skill in the art.

### SUMMARY

The method and device described herein have been made in an effort to provide a display device and a manufacturing method having reduced weight, thickness, cost, and processing time when manufacturing a single-substrate display device.

Also, the present inventive concept provides a display device with a simplified process and a reduced cost, and a manufacturing method thereof.

A display device according to an exemplary embodiment includes: a substrate; a thin film transistor disposed on the substrate; a pixel electrode connected to the thin film transistor; a roof layer disposed to be separated from the pixel electrode via a plurality of microcavities on the pixel electrode; a liquid crystal layer filling the microcavities; and an encapsulation layer disposed on the roof layer and sealing the microcavities, wherein the roof layer includes a partition positioned between the plurality of microcavities, and the partition has a width that decreases with increasing distance from the substrate.

The encapsulation layer may be positioned directly on the roof layer.

A first alignment layer may be positioned between the pixel electrode and at least one of the microcavities; and a second alignment layer may be positioned between the roof layer and at least one of the microcavities, wherein the second alignment layer may contact the roof layer.

A common electrode overlapping the pixel electrode, and an insulating layer between the common electrode and the pixel electrode may be further included.

The roof layer may include a photosensitive material.

The photosensitive material may be formed of a material that is cross-linked by a hardening process.

In another aspect, the inventive concept pertains to a manufacturing method of a display device that includes: forming a thin film transistor on a substrate; forming a pixel electrode connected to the thin film transistor; forming a photoresist on the pixel electrode; exposing the photoresist by using a mask; hardening the exposed photoresist; exposing the photoresist that is hardened; developing the photoresist that is entirely exposed to form a roof layer separated from the pixel electrode via the plurality of microcavities; injecting a liquid crystal material into the microcavities to form a liquid crystal layer; and forming an encapsulation layer on the roof layer to seal the microcavities.

The photoresist may be a positive photoresist.

The mask may be formed of a half-tone mask or a slit mask.

The mask may include a transmitting part that transmits substantially all of incident light, a half-transmitting part that partially transmits the incident light, and a non-transmitting part that blocks the incident light.

The developing includes forming a first portion of the photoresist corresponding to the transmitting part of the mask, forming the microcavities by removing a lower portion in a second portion of the photoresist corresponding to the half-transmitting part of the mask, and removing a third portion of the photoresist corresponding to the non-transmitting part of the mask.

The photoresist may include a photosensitive material that is cross-linked by the hardening process.

The hardening may include causing the first portion of the photoresist corresponding to the transmitting part of the mask to be cross-linked, and causing the upper portion may be cross-linked in the second portion of the photoresist corresponding to the half-transmitting part of the mask.

The roof layer may include a partition positioned between the plurality of microcavities, and the first portion of the photoresist corresponding to the transmitting part of the mask may become the partition.

The partition may have a width that decreases with distance from the substrate.

The encapsulation layer may be positioned directly on the roof layer.

The method wherein the hardening is a first-hardening, further including second-hardening the roof layer.

The first-hardening may be performed through low temperature heat treatment and the second-hardening may be performed through high temperature heat treatment.

The method may further include injecting an aligning agent in the microcavities to form an alignment layer after forming the roof layer, wherein the alignment layer may contact the roof layer.

The method may further include forming a common electrode overlapping the pixel electrode with the insulating layer between the common electrode and the pixel electrode.

The display device and the manufacturing method according to an exemplary embodiment of the present invention have the following effects.

According to the exemplary embodiments of the present invention, it is possible to reduce weight, thickness, cost, and processing time by manufacturing the display device by using one substrate.

Also, the manufacturing process of the display device may be simplified such that the cost may be reduced.

### BRIEF DESCRIPTION OF THE DRAWINGS

FIG. 1 is a top plan view of a display device according to an exemplary embodiment of the present inventive concept.

FIG. 2 is a partial layout view of a display device according to an exemplary embodiment of the present inventive concept.

FIG. 3 is a cross-sectional view of a display device according to an exemplary embodiment of the present invention taken along a line III-III of FIG. 2.

FIG. 4 is a cross-sectional view of a display device according to an exemplary embodiment of the present invention taken along a line IV-IV of FIG. 2.

FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, and FIG. 18 are cross-sectional views showing a manufacturing method of a display device according to an exemplary embodiment of the present inventive concept.

### DETAILED DESCRIPTION OF THE EMBODIMENTS

The present inventive concept will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Hereinafter, a display device according to an exemplary embodiment will be schematically described with reference to the accompanying drawings.

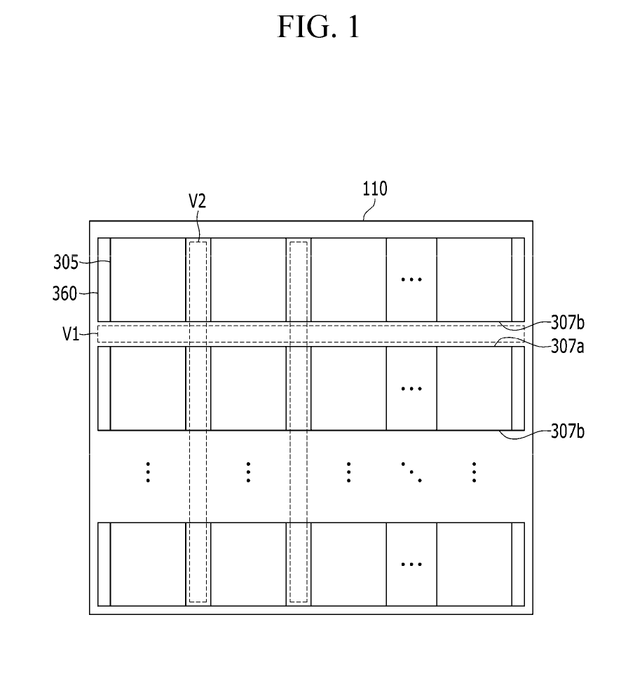

FIG. 1 is a top plan view of a display device according to an exemplary embodiment.

A display device according to the exemplary embodiment includes a substrate 110 made of a material such as glass or plastic.

A microcavity 305 covered by a roof layer 360 is formed on the substrate 110. The roof layer 360 extends in a row direction, and a plurality of microcavities 305 are formed below a single roof layer 360.

The microcavities 305 may be disposed in a matrix configuration, first valleys V1 are positioned between the microcavities 305 adjacent to each other in a column direction, and second valleys V2 are positioned between microcavities 305 adjacent to each other in a row direction.

A plurality of roof layers 360 are separated from each other with the first valleys V1 therebetween. The microcavity 305 is not covered by the roof layer 360, but may be exposed to the outside at a portion adjacent to the first valley V1. This is called injection holes 307a and 307b.

The injection holes 307a and 307b are formed at two ends of a microcavity 305. The injection holes 307a and 307b include a first injection hole 307a and a second injection hole 307b. The first injection hole 307a is formed to expose a lateral surface of a first edge of the microcavity 305, while the second injection hole 307b is formed to expose a lateral surface of a second edge of the microcavity 305. The lateral surface of the first edge and the lateral surface of the second edge of the microcavity 305 face each other, and are approximately perpendicular to the surface of the substrate 110.

Each roof layer 360 is spaced apart from the substrate 110 between the adjacent second valleys V2 to form the microcavity 305. The roof layer 360 covers the lateral surfaces other than the lateral surfaces of the first edge and the second edge in which the injection holes 307a and 307b are formed.

The aforementioned structure of the display device is just an example emboidment, and various modifications are contemplated. For example, an arrangement of the microcavity 305, the first valley V1, and the second valley V2 may be changed, the plurality of roof layers 360 may be connected to each other in the first valley V1, and a portion of each roof layer 360 may be formed to be spaced apart from the substrate 110 in the second valley V2 to connect the adjacent microcavities 305 to each other.

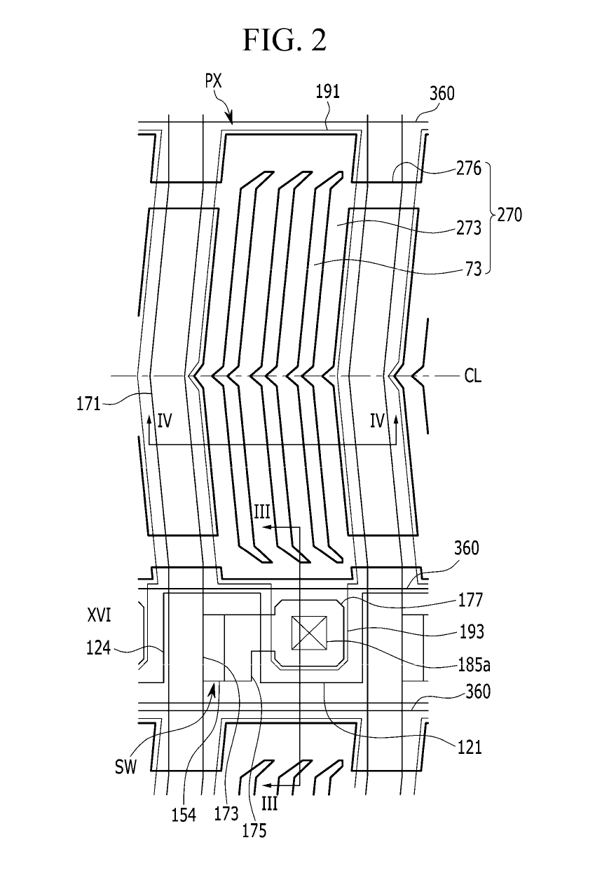

Hereinafter, a structure of one pixel of the display device according to an exemplary embodiment will be described with reference to FIG. 2 to FIG. 4.

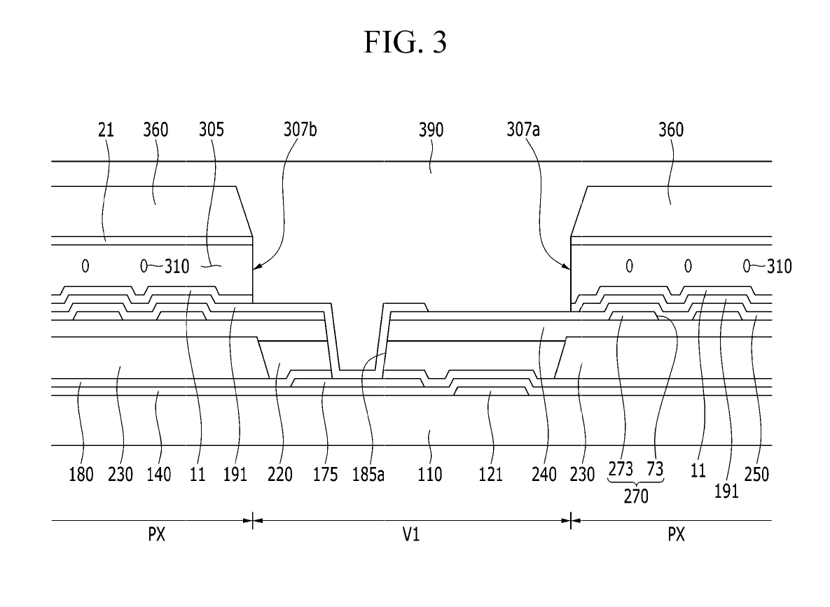

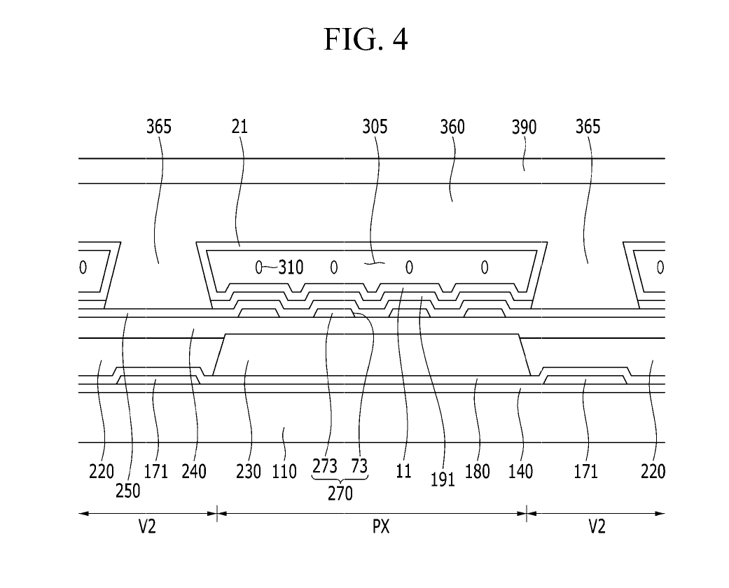

FIG. 2 is a partial layout view of a display device according to an exemplary embodiment, FIG. 3 is a cross-sectional view of a display device according to an exemplary embodiment taken along a line III-III of FIG. 2, and FIG. 4 is a cross-sectional view of a display device according to an exemplary embodiment taken along a line IV-IV of FIG. 2.

Referring to FIG. 2 to FIG. 4, a gate line 121 and a gate electrode 124 protruding from the gate line 121 are formed on the insulation substrate 110 made of transparent glass or plastic.

The gate line 121 may mainly extend in a horizontal direction and transmit a gate signal. The gate line 121 may be positioned between the microcavities 305 that neighbor each other in a column direction. That is, the gate line 121 may be positioned along the first valley V1.

A gate insulating layer 140 is formed on the gate line 121 and the gate electrode 124. The gate insulating layer 140 may be formed of an inorganic insulating material, such as a silicon nitride (SiNx) and a silicon oxide (SiOx). Further, the gate insulating layer 140 may be formed of a single layer or a multilayer.

A semiconductor 154 is formed on the gate insulating layer 140. The semiconductor 154 may be positioned on the gate electrode 124. If necessary, the semiconductor 154 may also be positioned under the data line 171. The semiconductor 154 may be formed of amorphous silicon, polycrystalline silicon, or a metal oxide.

An ohmic contact (not shown) may be further formed on the semiconductor 154. The ohmic contact may be made of a silicide or of n+ hydrogenated amorphous silicon doped with an n-type impurity at a high concentration.

A data line 171 and a drain electrode 175 separated from the data line 171 are formed on the semiconductor 154 and the gate insulating layer 140. The data line 171 includes a source electrode 173, and the source electrode 173 and the drain electrode 175 are positioned to face each other.

The data line 171 transmits a data signal and mainly extends in the vertical direction, thereby crossing the gate line 121. The data line 171 is positioned between the microcavities 305 that neighbor each other in the row direction. That is, the data line 171 is positioned along the second valley V2. The data line 171 may curve periodically. For example, as illustrated in FIG. 2, each data line 171 may curve at least once at a portion corresponding to a horizontal center line CL of one pixel PX.

As shown in FIG. 2, the source electrode 173 does not protrude from the data line 171, and may be positioned on the same line as the data line 171. The drain electrode 175 may include a rod-shaped portion extending substantially parallel to the source electrode 173, and an extension 177 that is opposite to the rod-shaped portion.

The gate electrode 124, the source electrode 173, and the drain electrode 175 form one thin film transistor (TFT) together with the semiconductor 154. The thin film transistor may function as a switching element SW for transmitting the data voltage of the data line 171. In this case, a channel of the switching element SW is formed in the semiconductor 154 between the source electrode 173 and the drain electrode 175.

A first passivation layer 180 is formed on the data line 171, the source electrode 173, the drain electrode 175, and the exposed portion of the semiconductor 154. The first passivation layer 180 may be made of the organic insulating material or the inorganic insulating material, and may be formed of a single layer or multiple layers.

A color filter 230 is formed in each pixel PX on the first passivation layer 180.

Each color filter 230 may display one among primary colors such as three primary colors of red, green, and blue. The color filter 230 is not limited to the three primary colors of red, green, and blue, and may also display cyan, magenta, yellow, and white-based colors. The color filter 230 may not be formed in the first valley V1 and/or the second valley V2.

A light blocking member 220 is formed in a region between the adjacent color filters 230. The light blocking member 220 is formed on a boundary of the pixel PX and the switching element to prevent light leakage. That is, the light blocking member 220 may be formed in the first valley V1 and the second valley V2.

However, the present exemplary embodiment is not limited thereto, and the light blocking member 220 may be formed in the first valley V1 but not in the second valley V2 in other embodiments. The color filter 230 and the light blocking member 220 may overlap each other on the partial region.

A second passivation layer 240 may be further formed on the color filter 230 and the light blocking member 220. The second passivation layer 240 may be formed of an organic insulating material, and may serve to planarize the upper surface of the color filter 230 and the light blocking member 220. The second passivation layer 240 may be made of a dual layer including a layer made of an organic insulating material and a layer made of an inorganic insulating material. In some cases, the second passivation layer 240 may be omitted.

A common electrode 270 is positioned on the second passivation layer 240. Common electrodes 270 positioned in the plurality of pixels PX are connected to each other through a connection bridge 276 and the like to transfer substantially the same common voltage Vcom. The common electrode 270 may include a plurality of branch electrodes 273. A slit 73 in which an electrode is removed is formed between the adjacent branch electrodes 273. The common electrode 270 may be made of a transparent metal oxide such as ITO and IZO.

An insulating layer 250 is formed on the common electrode 270. The insulating layer 250 may be made of the inorganic insulating material such as a silicon nitride (SiNx) and a silicon oxide (SiOx).

The first passivation layer 180, the second passivation layer 240, and the insulating layer 250 have a contact hole 185a exposing a portion of the drain electrode 175, for example, the extension 177.

A pixel electrode 191 is formed on the insulating layer 250. The pixel electrode 191 of each pixel PX may have a planar shape. The pixel electrode 191 overlaps a plurality of branch electrodes 273 of the common electrode 270. The pixel electrode 191 and the common electrode 270 are separated by the insulating layer 250. The insulating layer 250 insulates the pixel electrode 191 and the common electrode 270.

The pixel electrode 191 may include a protrusion 193 for connection with other layers. The protrusion 193 of the pixel electrode 191 is physically and electrically connected to the drain electrode 175 through the contact hole 185a to receive a voltage from the drain electrode 175. The pixel electrode 191 may be made of a conductive material such as a transparent metal oxide of ITO or IZO.

The pixel electrode 191 may include an edge that is curved along the curved shape of the data line 171. For example, the pixel electrode 191 may be formed as a polygon including an edge that is bent at the portion corresponding to the transverse center line CL of the pixel PX.

The arrangement and shape of the described pixel and the shape of the thin film transistor may be changed. Also, the deposition positions of the pixel electrode 191 and the common electrode 270 may be interchanged with each other. That is, the insulating layer 250 is formed on the common electrode 270 and the pixel electrode 191 is formed on the insulating layer 250. However, the insulating layer may be formed on the pixel electrode and the common electrode may be formed on the insulating layer. Also, the pixel electrode 191 may include the branch electrodes and the slits and the common electrode 270 may be formed in a plate shape.

The roof layer 360 separated from the pixel electrode 191 is formed on the pixel electrode 191. The microcavity 305 is formed between the pixel electrode 191 and the roof layer 360. That is, the microcavity 305 is enclosed by the pixel electrode 191 and the roof layer 360. A width of an area of the microcavity 305 may be variously changed depending on the size of the display device and the resolution.

The roof layer 360 extends in the row direction and is formed on the microcavities 305 and at the second valley V2. The roof layer 360 is formed to cover the upper surface and the side surface of the microcavity 305. A partition 365 is formed between a plurality of microcavities 305, and the partition 365 forms a portion of the roof layer 360. The partition 365 is formed at the second valley V2 and separates the microcavities 305 adjacent in the row direction. The roof layer 360 may be hardened by a hardening process to maintain the shape of the microcavity 305.

The roof layer 360 may be formed of the transparent organic material and may include a photosensitive material. For example, the roof layer 360 may include a transparent material such as an acrylic resin as a backbone and a photosensitive material such as DNQ-4-sulfonyl chloride. DNQ-4-sulfonyl chloride is represented by Chemical Formula 1.

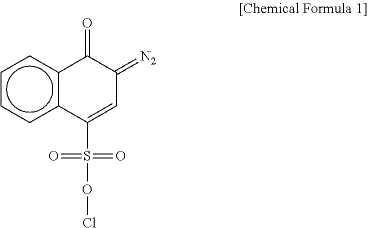

It is preferable that the material forming the roof layer 360 is made of a material that is cross-linked by the hardening process providing heat. In the example, DNQ-4-sulfonyl chloride is the photosensitive material that is cross-linked by the hardening process. This is only an example, and it may be changed into various materials that are cross-linked by the hardening process.

Alignment layers 11 and 21 are formed on the pixel electrode 191 and under the roof layer 360.

The alignment layers 11 and 21 include a first alignment layer 11 and a second alignment layer 21. The first alignment layer 11 and the second alignment layer 21 may be horizontal alignment layers and may be formed of an alignment material such as polyamic acid, polysiloxane, and polyimide. The first and second alignment layers 11 and 21 may be connected at the lateral wall of the edge of the microcavity 305.

The first alignment layer 11 is formed on the pixel electrode 191. The first alignment layer 11 may be formed directly on the second passivation layer 240 that is not covered by the pixel electrode 191.

The second alignment layer 21 is formed under the roof layer 360 to face the first alignment layer 11.

A liquid crystal layer made of liquid crystal molecules 310 is formed in the microcavity 305 positioned between the pixel electrode 191 and the common electrode 270. The liquid crystal molecules 310 have positive dielectric anisotropy or negative dielectric anisotropy. The liquid crystal molecules 310 may be arranged such that its long axis is aligned parallel to the substrate 110 in the absence of the electric field. That is, a horizontal alignment may be realized.

The pixel electrode 191 applied with the data voltage through the switching element SW generates the electric field along with the common electrode 270 applied with the common voltage Vcom such that the direction of the liquid crystal molecules 310 of the liquid crystal layer positioned in the microcavities 305 is determined. Particularly, the branch electrodes 273 of the common electrode 270 form a fringe field to the liquid crystal layer along with the pixel electrode 191, thereby determining the alignment direction of the liquid crystal molecules 310. As such, luminance of light passing through the liquid crystal layer varies according to the determined alignment directions of the liquid crystal molecules 310, thereby displaying the screen.

The roof layer 360 is formed to expose a portion of the side surface of the edge of the microcavity 305, and portions where the microcavity 305 is not covered by the common electrode 270 and the roof layer 360 are referred to as injection holes 307a and 307b. The injection holes 307a and 307b include a first injection hole 307a through which a lateral surface of a first edge of the microcavity 305 is exposed, and a second injection hole 307b through which a lateral surface of a second edge of the microcavity 305 is exposed. The first edge and the second edge are edges facing each other, and for example, in the plane view, the first edge may be an upper edge of the microcavity 305 and the second edge may be a lower edge of the microcavity 305. In the manufacturing process of the display device, the microcavities 305 are exposed by the injection holes 307a and 307b, so that an alignment solution, a liquid crystal material, or the like may be injected into the microcavities 305 through the injection holes 307a and 306b.

An encapsulation layer 390 is formed on the roof layer 360. The encapsulation layer 390 is formed to cover the injection holes 307a and 307b exposing the portion of the microcavity 305. That is, the encapsulation layer 390 may seal the microcavity 305 so that the liquid crystal molecules 310 formed in the microcavity 305 are not discharged to the outside. The encapsulation layer 390 contacts the liquid crystal 310, and as a result, the encapsulation layer 390 may be made of a material which does not react with the liquid crystal molecules 310. For example, the encapsulation layer 390 may be made of parylene and the like.

The encapsulation layer 390 may be formed by a multilayer such as a double layer and a triple layer. The double layer is configured by two layers made of different materials. The triple layer is configured by three layers, and materials of adjacent layers are different from each other. For example, the encapsulation layer 390 may include a layer made of an organic insulating material or a layer made of an inorganic insulating material.

Since the roof layer 360 is formed of the organic material, an insulating layer made of the inorganic insulating material such as a silicon nitride (SiNx) and a silicon oxide (SiOx) is commonly formed on and under the roof layer 360 to prevent the roof layer 360 from being damaged during the manufacturing process. In the present disclosure, the shape of the roof layer 360 may be formed without the formation of the inorganic insulating layer, thereby realizing process simplification and cost reduction. A detailed description of the roof layer 360 will be described below.

Since there is no separate inorganic insulating layer formed on and under the roof layer 360, the roof layer 360 contacts the second alignment layer 21 positioned thereunder and also contacts the encapsulation layer 390 positioned thereon. That is, the second alignment layer 21 may be positioned directly under the roof layer 360 and the encapsulation layer 390 may be positioned directly on the roof layer 360.

Although not illustrated in the drawings, a polarizer may be formed on upper and lower surfaces of the display device. The polarizer may be formed of a first polarizer and a second polarizer. The first polarizer may be attached to a lower surface of the substrate 110, and the second polarizer may be attached onto the encapsulation layer 390.

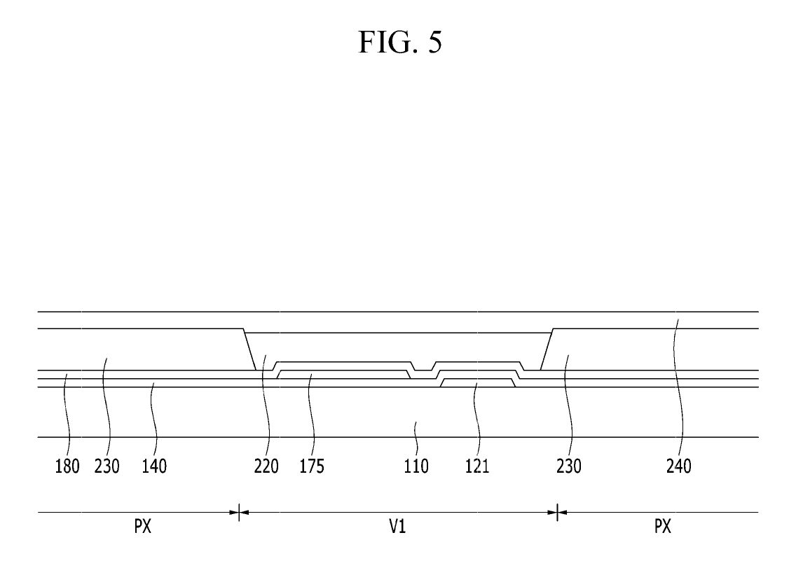

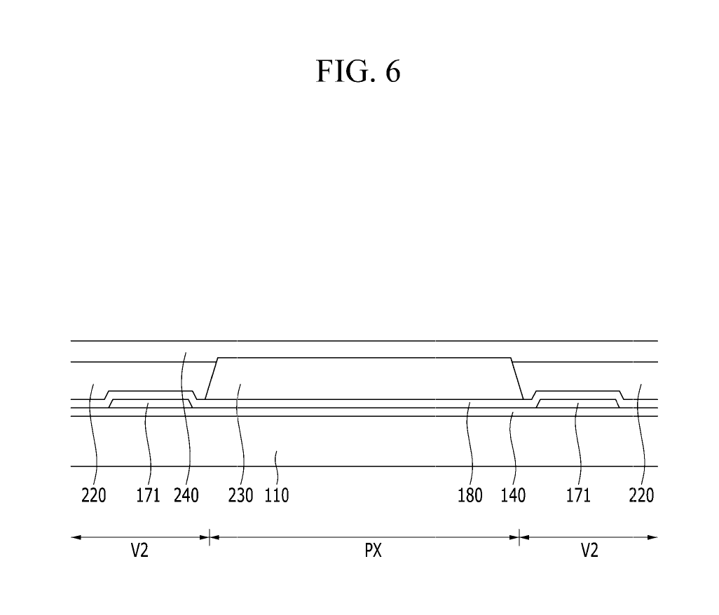

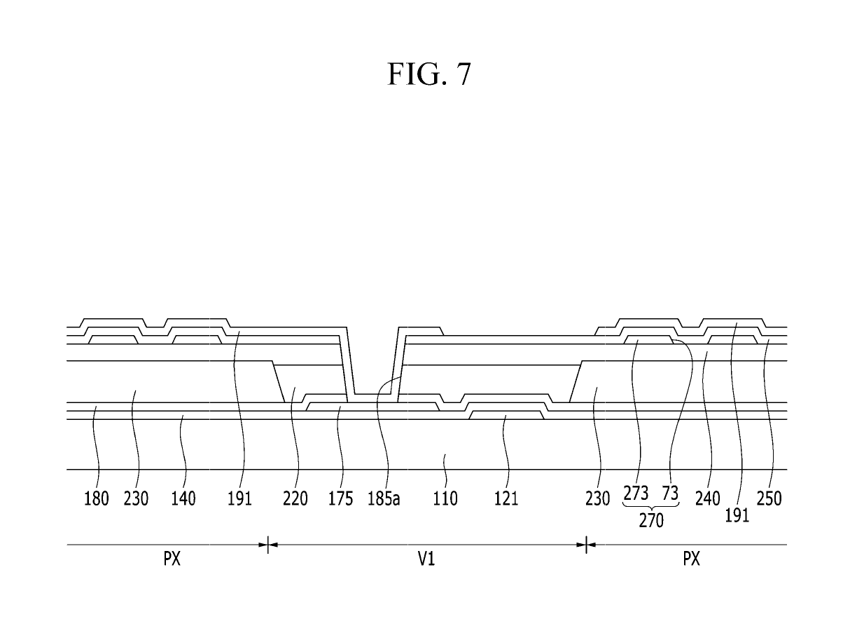

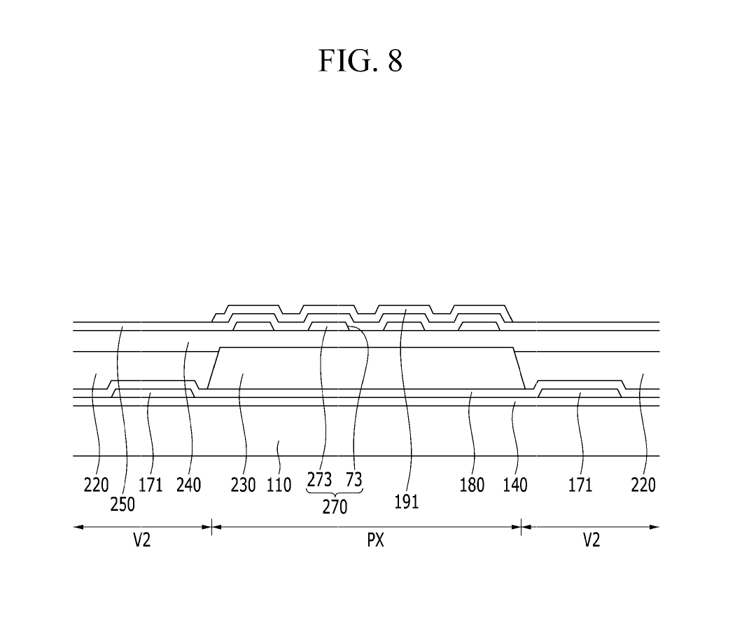

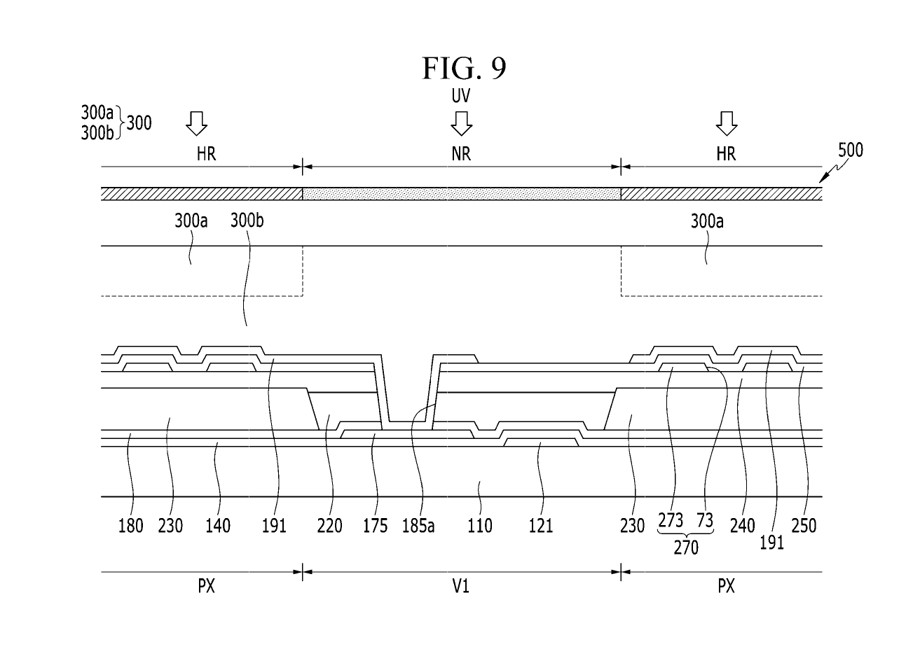

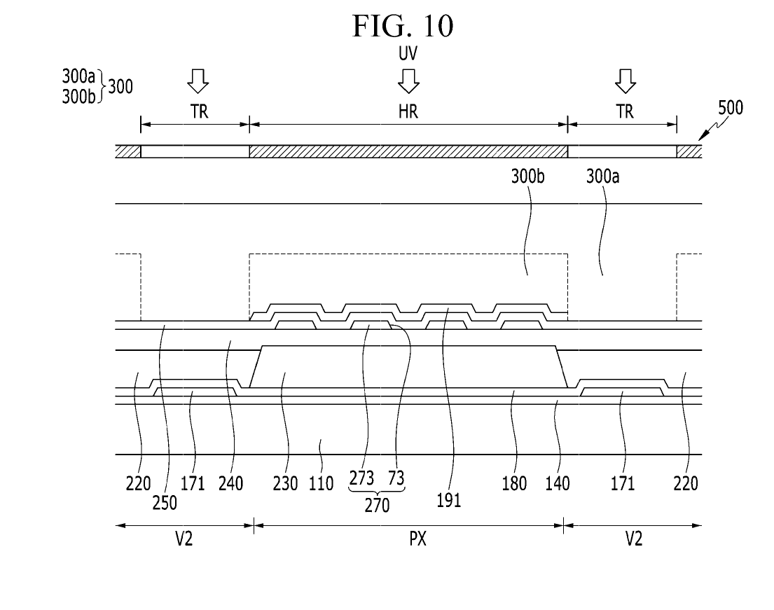

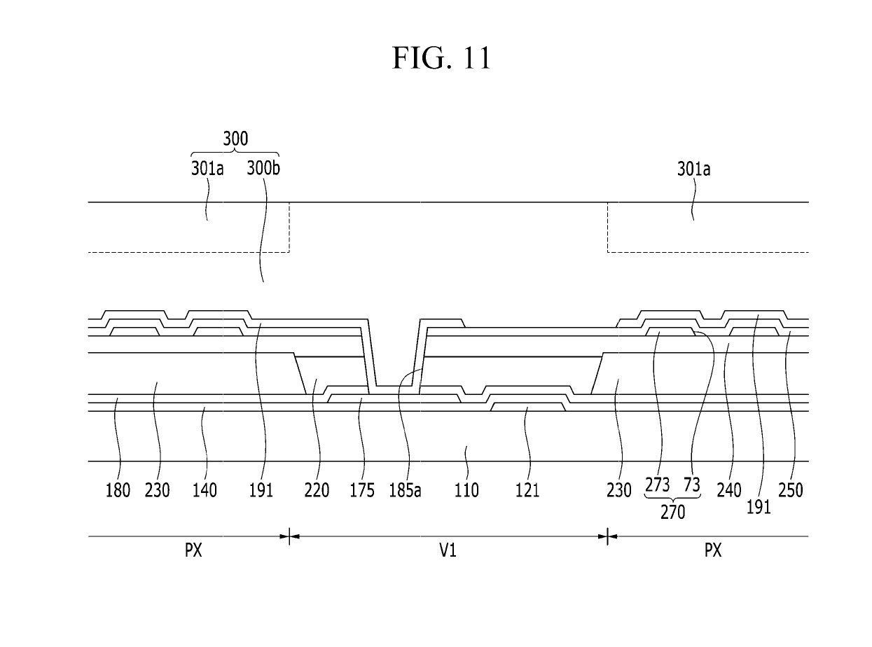

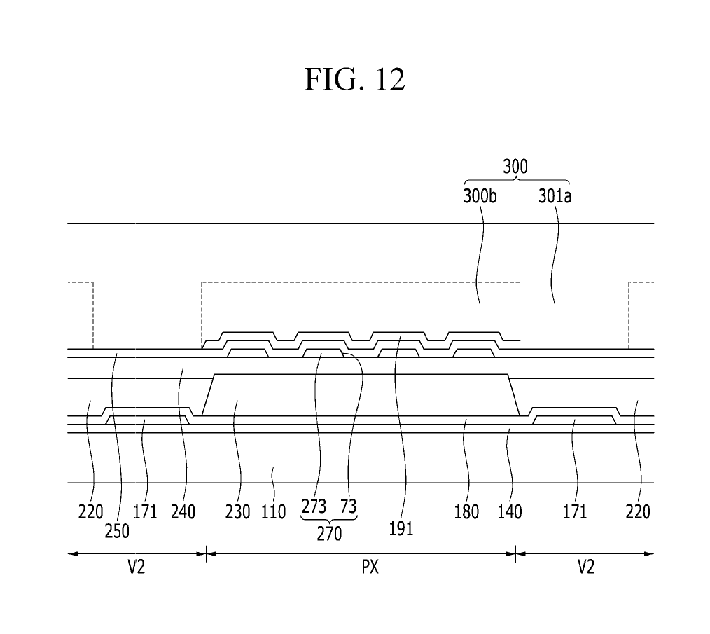

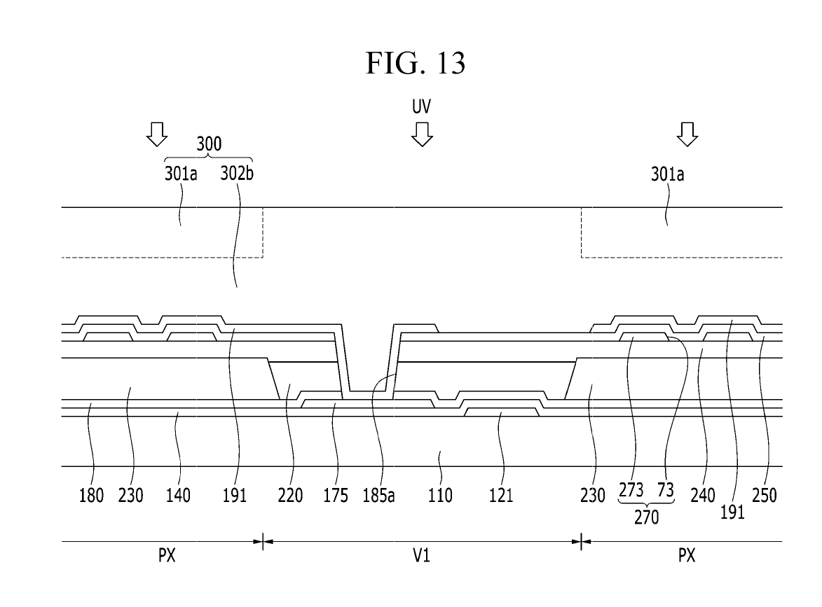

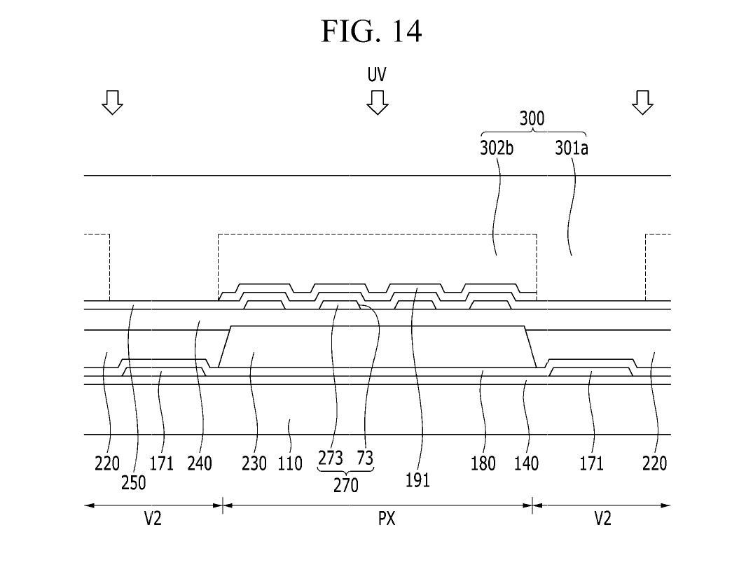

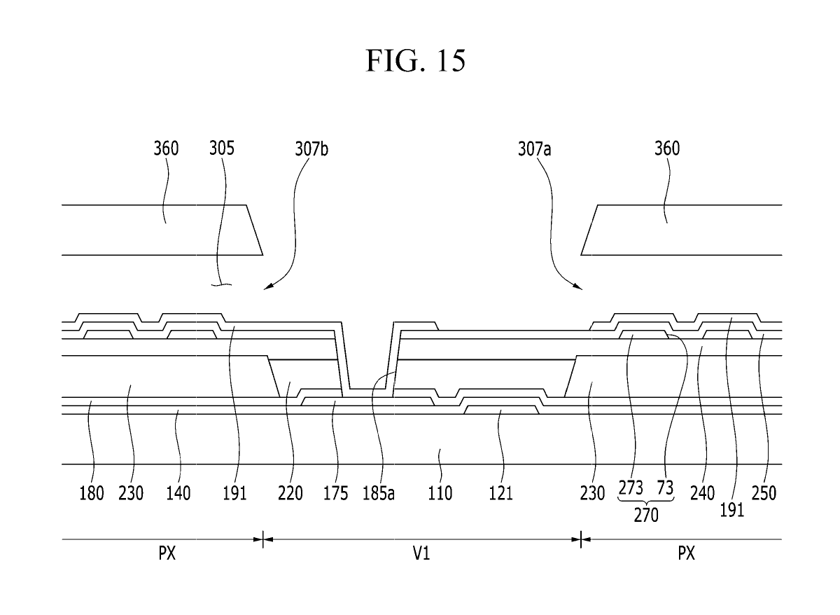

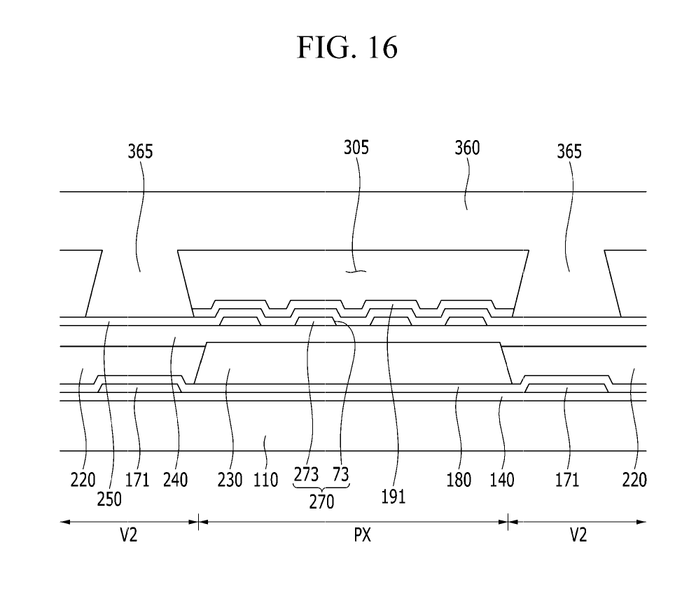

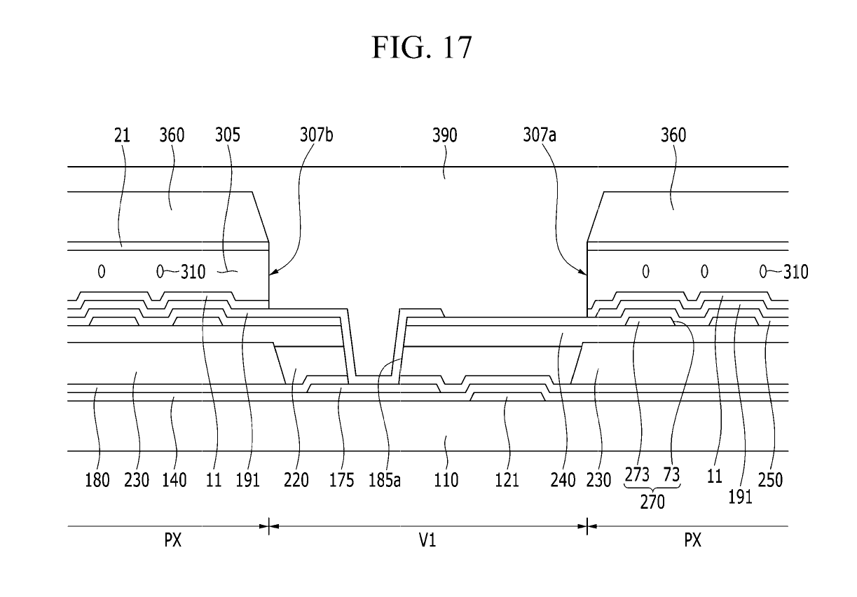

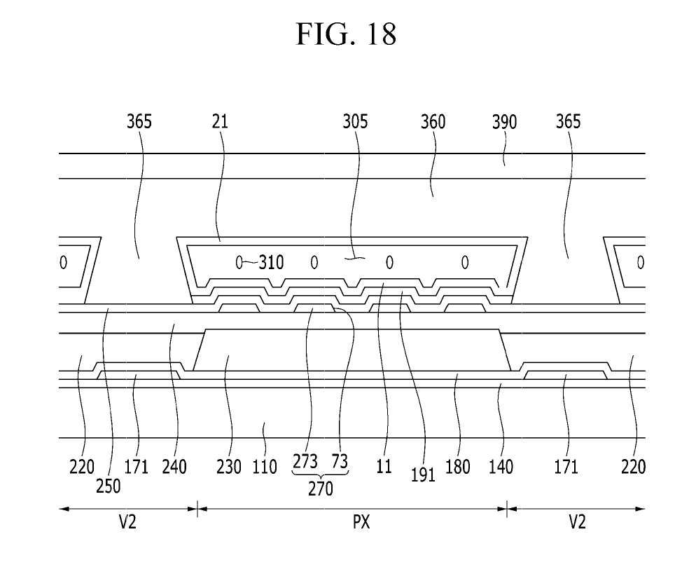

Next, a manufacturing method of the display device according to an exemplary embodiment of the present invention will be described below with reference to FIG. 5 to FIG. 18. Furthermore, FIG. 1 to FIG. 4 will also be referred to.

FIG. 5 to FIG. 18 are process cross-sectional views showing a manufacturing method of a display device according to an exemplary embodiment. FIG. 5, FIG. 7, FIG. 9, FIG. 11, FIG. 13, FIG. 15, and FIG. 17 are cross-sectional views taken along the same line. Also, FIG. 6, FIG. 8, FIG. 10, FIG. 12, FIG. 14, FIG. 16, and FIG. 18 are cross-sectional views taken along the same line.

Firstly, as shown in FIG. 5 and FIG. 6, a gate line 121 and a gate electrode 124 protruding from the gate line 121 are formed on a substrate 110 made of glass or plastic. The gate line 121 may mainly extend in the horizontal direction.

Next, a gate insulating layer 140 is formed on the gate line 121 and the gate electrode 124 by using the inorganic insulating material such as a silicon nitride (SiNx) and a silicon oxide (SiOx). The gate insulating layer 140 may be made of a single layer or multiple layers.

Next, a semiconductor material such as amorphous silicon, polycrystalline silicon, and a metal oxide is deposited and patterned on the gate insulating layer 140 to form a semiconductor 154. The semiconductor 154 may be formed to be positioned on the gate electrode 124.

Next, a metal material is deposited and patterned on the semiconductor 154 and the gate insulating layer 140 to form a data line 171 and a drain electrode 175 separated from the data line 171. The metal material may be made of a single layer or multiple layers.

The data line 171 may mainly extend in the vertical direction. The data line 171 may periodically curve. The data line 171 includes a source electrode 173, and the source electrode 173 and the drain electrode 175 are positioned to face each other. The drain electrode 175 may include a rod-shaped portion extending substantially in parallel with the source electrode 173, and an extension 177 which is opposite to the rod-shaped portion.

The semiconductor material and the metal material may be continuously deposited and simultaneously patterned to form the semiconductor layer 154, the data line 171, the source electrode 173, and the drain electrode 175. At this time, the semiconductor layer 154 is also formed under the data line 171.

The gate electrode 124, the semiconductor layer 154, the source electrode 173, and the drain electrode 175 form one thin film transistor. The thin film transistor may function as the switching element SW transmitting the data voltage of the data line 171. In this case, the channel of the switching element SW is formed in the semiconductor 154 between the source electrode 173 and the drain electrode 175.

Next, a first passivation layer 180 is formed on the data line 171, the source electrode 173, the drain electrode 175, and the exposed portion of the semiconductor 154. The first passivation layer 180 may be made of the organic insulating material or an inorganic insulating material, and may be formed of a single layer or multiple layers.

Next, a color filter 230 is formed on the first passivation layer 180. The color filter 230 is formed in the pixel PX, however it may not be formed in the first valley V1. Color filters 230 having the same color may be formed in a column direction of the plurality of pixels PX. In the case of forming the color filters 230 having three colors, a first colored color filter 230 may be formed first, a second colored color filter 230 may then be formed by shifting a mask, and then a third colored color filter 230 may be formed by shifting the mask again.

Next, a light blocking member 220 is formed at the boundary of each pixel PX on the first passivation layer 180 and on the switching element SW by a material that blocks light.

The light blocking member 220 is positioned in the first valley V1 and the second valley V2. The switching element SW is positioned in the first valley V1, and the light blocking member 220 is formed to overlap the switching element SW. Furthermore, the light blocking member 220 may be formed to overlap the gate line 121 and the data line 171.

Next, a second passivation layer 240 of the organic insulating material is formed on the color filter 230 and the light blocking member 220. The second passivation layer 240 may flatten the upper surface of the color filter 230 and the light blocking member 220. The second passivation layer 240 may be formed of a dual layer including a layer made of the organic insulating material and a layer made of the inorganic insulating material. The second passivation layer 240 may be omitted in some cases.

As shown in FIG. 7 and FIG. 8, the transparent metal oxide such as ITO (Indium Tin Oxide) or IZO (Indium Zinc Oxide) is deposited and patterned on the second passivation layer 240 to form a common electrode 270. Common electrodes 270 positioned in the plurality of pixels PX are connected to each other through a connection bridge 276 and the like to transfer substantially the same common voltage Vcom. The common electrode 270 that includes the plurality of branch electrodes 273 and a slit 73 where there is no electrode is formed between the adjacent branch electrodes 273.

Next, an insulating layer 250 made of the inorganic insulating material such as a silicon oxide (SiOx) or a silicon nitride (SiNx) is formed on the common electrode 270.

Next, the first passivation layer 180, the second passivation layer 240, and the insulating layer 250 are patterned to form a contact hole 185a exposing at least a portion of the drain electrode 175, for example, the expansion 177.

Next, the transparent metal oxide such as ITO and IZO is deposited and patterned on the insulating layer 250 to form a pixel electrode 191 in each pixel PX. The pixel electrode 191 may have a planar shape. The pixel electrode 191 overlaps the plurality of branch electrodes 273 of the common electrode 270. The pixel electrode 191 and the common electrode 270 are separated by the insulating layer 250. The insulating layer 250 insulates the pixel electrode 191 and the common electrode 270.

The pixel electrode 191 may include a protrusion 193 for connection with other layers. The protrusion 193 of the pixel electrode 191 is physically and electrically connected to the drain electrode 175 through the contact hole 185a to receive a voltage from the drain electrode 175. The pixel electrode 191 may include an edge that is curved along the curved shape of the data line 171.

The arrangement and shape of the described pixel and the shape of the thin film transistor may be changed. Also, the deposition order of the pixel electrode 191 and the common electrode 270 may be changed. That is, the common electrode 270 is firstly formed and the insulating layer 250 and the pixel electrode 191 are then sequentially formed in some embodiments. However the pixel electrode may be firstly formed and then the insulating layer and the common electrode may be sequentially formed in other embodiments. Also, the pixel electrode 191 may include the branch electrode and the slit, and the common electrode 270 may be formed in a plate shape.

As shown in FIG. 9 and FIG. 10, a photoresist 300 is formed on the pixel electrode 191. The photoresist 300 is a positive photoresist. The positive photoresist increases solubility by generating decomposition by exposure, that is, a chain scission.

The photoresist 300 may be made of the organic material and may include a photosensitive material. For example, the photoresist 300 may include a transparent material such as an acrylic resin as a backbone and a photosensitive material such as DNQ-4-sulfonyl chloride. DNQ-4-sulfonyl chloride is represented by Chemical Formula 1.

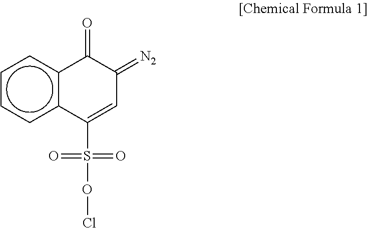

It is preferable that the material forming the roof layer 360 is made of a material that is cross-linked by a hardening process providing heat. In the example, DNQ-4-sulfonyl chloride is the photosensitive material that is cross-linked by the hardening process. This is only an example, and it may be changed into various materials that are cross-linked by the hardening process.

A mask 500 is positioned on the photoresist 300 and an exposure process of irradiating ultraviolet rays (UV) is executed. The mask 500 may be formed of a slit mask or a half-tone mask. The mask 500 includes a transmitting part TR, a non-transmitting part NR, and a half transmitting part HR.

The transmitting part TR is a region which transmits light irradiated to the mask 500, the non-transmitting part NR is a region which does not transmit light irradiated to the mask 500, and the half transmitting part HR is a region which transmits some but not all of the light irradiated to the mask 500.

The portion of the photoresist 300 irradiated by the exposure process experiences a chemical change. Since the photoresist 300 according to an exemplary embodiment is a positive photoresist, the solubility of the portion that is irradiated is increased and becomes a high solubility region 300a. The portion that is not irradiated does not go through a chemical change and has relatively low solubility, thereby being referred to as a low solubility region 300b.

A first portion of the photoresist 300 corresponding to the transmitting part TR of the mask 500 is fully irradiated by light, thereby being the high solubility region 300a. A second portion of the photoresist 300 corresponding to the half-transmitting part HR of the mask 500 is partially irradiated, thereby being divided into the high solubility region 300a and the low solubility region 300b. In this case, an upper part and a lower part of the photoresist 300 are divided, the light reaches the upper part, and the light does not reach the lower part. Accordingly, the upper part becomes the high solubility region 300a and the lower part becomes the low solubility region 300b. The third portion of the photoresist 300 corresponding to the non-transmitting NR of the mask 500 is not irradiated by light, thereby being the low solubility region 300b.

In this way, if the photoresist is formed and the exposure process is executed by using the mask, two regions having different solubility are formed.

As shown in FIG. 11 and FIG. 12, heat is applied to the exposed photoresist 300 for a first hardening process. The first hardening process is executed at a low temperature and is referred to as a pre-bake process. For example, the first hardening process may be executed at a temperature of 100° C. to 150° C.

The photoresist includes the photosensitive material that is cross-linked by the hardening process such that the photoresist 300 is cross-linked by the hardening process. Particularly, the cross-link is performed in the high solubility region 300a of the photoresist 300. The solubility of the region in which the cross-link is generated is decreased, and the corresponding region is referred to as a cross-link region 301a. In the low solubility region 300b, the cross-link is not generated and the chemical change is not generated.

Since the cross-link is generated in the first portion of the photoresist 300 corresponding to the transmitting part of the mask 500, the first portion is changed into the cross-link region 301a from the high solubility region 300a. The upper portion of the second portion of the photoresist 300 corresponding to the half-transmitting part HR of the mask 500 is cross-linked such that it is changed from the high solubility region 300a into the cross-link region 301a. The lower portion of the second portion does not generate the chemical change such that it remains as the low solubility region 300b. The third portion of the photoresist 300 corresponding to the non-transmitting part NT of the mask 500 does not generate the chemical change such that the low solubility region 300b is maintained.

In this way, if the heat is applied to the two regions having different solubilities, the cross-link is generated in the high solubility region such that the solubility is decreased. In this process, the entire region of the photoresist 300 has low solubility.

As shown in FIG. 13 and FIG. 14, ultraviolet rays (UV) are irradiated to the photoresist 300 for hardening. This second irradiation is performed without a mask on the photoresist 300, such that the entire surface of photoresist 300 is exposed to light. Where the photoresist 300 is a positive photoresist, the original solubility of the irradiated portion is increased. However, the photoresist 300 that was hardened first includes the cross-link region 301a that is cross-linked, and the link of the cross-link region 301a is further enhanced by irradiation.

Accordingly, the link of the cross-link region 301a is further enhanced, and the solubility is further decreased. Also, the solubility of the low solubility region 300b is increased by irradiation such that a high solubility region 302b is formed.

In this way, if the entire photoresist in the region is cross-linked region is exposed, the solubility of the region that is cross-linked is decreased, and the solubility of the region that is not cross-linked is increased.

As shown in FIG. 15 and FIG. 16, the photoresist 300 that is fully exposed (without a mask) is developed. The high solubility region 302b is removed by the development process, and the cross link region 301a remains.

As a result, the first portion of the photoresist 300 corresponding to the transmitting part TR of the mask 500 remains, and the upper portion remains in the second portion of the photoresist 300 corresponding to the half-transmitting part HR of the mask 500 such that the roof layer 360 is formed. Also, the lower portion is removed in the second portion of the photoresist 300 corresponding to the half-transmitting part HR of the mask 500 such that the microcavity 305 is formed. Also, the third portion of the photoresist 300 corresponding to the non-transmitting part NR of the mask 500 is removed. Instead of using a sacrificial layer as in other manufacturing processes, the inventive technique utilizes the cross-linking property of a photoresist that affects the photoresist's reaction to light to form the roof layer for a single-substrate display device.

In this case, the photoresist 300 positioned in the first valley V1 is removed, in some cases in its entirety, such that at least a portion of the microcavity 305 is exposed. The portions through which the microcavity 305 is exposed are called the injection holes 307a and 307b. The two injection holes 307a and 307b may be formed in one microcavity 305, and for example, the first injection hole 307a through which the lateral surface of the first edge of the microcavity 305 is exposed and the second injection hole 307b through which the lateral surface of the second edge of the microcavity 305 is exposed may be formed. The first edge and the second edge face each other, and for example, the first edge may be the upper edge of the microcavity 305 and the second edge may be the lower edge of the microcavity 305.

The photoresist 300 positioned on the pixel PX and in the second valley V2 remains to form the roof layer 360. The roof layer 360 is formed of a shape such that the roof layer 360 is connected along a plurality of pixel rows. In this case, the lower portion of the photoresist 300 positioned at the pixel PX is removed such that the microcavity 305 is formed, and the photoresist 300 positioned at the second valley V2 remains such that the partition 365 is formed. The partition 365 forms the portion of the roof layer 360, thereby separating the adjacent microcavities 305.

If the roof layer 360 is formed by the development process, a secondary hardening process is performed by applying the heat to the roof layer 360. The secondary hardening process is performed at a high temperature, and it is referred to as a real hardening process. The roof layer 360 becomes harder by the secondary hardening process such that the shape of the microcavity 305 may be normally maintained under the roof layer 360.

In the secondary hardening process, while applying the heat of the high temperature, the roof layer 360 is formed of a shape in which the lower portion is wider than the upper portion, the lower portion being closer to the substrate 110 than the upper portion.

In an exemplary embodiment of the present disclosure, the photoresist is formed and photoprocess and hardening process are performed to form the roof layer 360.

This process stands in contrast to the traditional technique of forming the roof layer through a process of forming a sacrificial layer forming the roof layer on the sacrificial layer, and removing the sacrificial layer, the photoprocess is required twice and an etching process is required twice, as well as a dry etching process. An exemplary embodiment of the present inventive concept simplifies the manufacturing process and reduces cost.

Also, in the process of forming and removing the sacrificial layer, to prevent the roof layer from being damaged, an insulating layer of the inorganic insulating material such as a silicon nitride (SiNx) and a silicon oxide (SiOx) is generally formed on and under the roof layer. In the method and device of the present disclosure, the shape of the roof layer 360 may be formed without also forming the inorganic insulating layer such that the process simplification and the cost reduction may be realized.

It is conventional for the sacrificial layer to be formed such that the lower portion is wider than the upper portion, causing the roof layer to be wider in the upper portion than in the lower portion. Accordingly, the partition of the roof layer ends up being wider farther away from the substrate such that an unstable structure is formed. In contrast, in an exemplary embodiment of the present disclosure, the partition of the roof layer has a stable shape that is narrower farther away from the substrate.

As shown in FIG. 17 and FIG. 18, when an aligning agent containing an alignment material is deposited on the substrate 110 by a spin coating method or an inkjet method, the aligning agent is injected into the microcavity 305 through the injection holes 307a and 307b. When the aligning agent is injected into the microcavity 305 and a curing process is performed, a solution component is evaporated and the alignment material remains on the inner wall of the microcavity 305.

Accordingly, the first alignment layer 11 may be formed on the pixel electrode 191, and the second alignment layer 21 may be formed below the roof layer 360. The first alignment layer 11 and the second alignment layer 21 face each other with the microcavity 305 therebetween, and may be connected to each other on a side wall of the edge of the microcavity 305.

In this case, the first and second alignment layers 11 and 21 may be formed as horizontal alignment layers.

Next, when the liquid crystal material is deposited on the substrate 110 by an inkjet method or a dispensing method, the liquid crystal material is injected into the microcavity 305 through the injection holes 307a and 307b by capillary force. Accordingly, the liquid crystal layer including liquid crystal molecules 310 is formed in the microcavity 305.

Next, an encapsulation layer 390 is formed by depositing a material which does not react with the liquid crystal molecules 310 on the roof layer 360. The encapsulation layer 390 is formed to cover the injection holes 307a and 306b to seal the microcavity 305 so that the liquid crystal molecules 310 formed in the microcavity 305 are not discharged outside.

As described above, since the inorganic insulating layer may not be present on and under the roof layer 360, the roof layer 360 directly contacts the second alignment layer 21 positioned thereunder and directly contacts the encapsulation layer 390 positioned thereon. That is, the second alignment layer 21 may be formed directly under the roof layer 360 and the encapsulation layer 390 may be formed directly on the roof layer 360.

Next, although not illustrated, polarizers may be further attached onto the upper and lower surfaces of the display device. The polarizers may be configured by a first polarizer and a second polarizer. The first polarizer may be attached onto the lower surface of the substrate 110, and the second polarizer may be attached onto the encapsulation layer 390.

While this invention has been described in connection with what is presently considered to be practical embodiments, it is to be understood that the inventive concept is not limited to the disclosed embodiments. On the contrary, the inventive concept is intended to cover various modifications and equivalent arrangements included within the spirit and scope of the disclosure.

### <Description of Symbols>

| | |
|---|---|
| 110: substrate | 121: gate line |
| 124: gate electrode | 140: gate insulating layer |
| 154: semiconductor | 171: gate line |
| 173: source electrode | 175: drain electrode |
| 180: first passivation layer | 185a: contact hole |
| 191: pixel electrode | 220: light blocking member |
| 230: color filter | 240: second passivation layer |
| 250: insulating layer | 270: common electrode |
| 300: photoresist | 305: microcavities |
| 307a, 307b: injection hole | 310: liquid crystal molecule |
| 360: roof layer | 365: roof layer [symbol] partition |
| 390: encapsulation layer | 500: mask |

What is claimed is:

1. A display device comprising:
a substrate;
a thin film transistor disposed on the substrate;
a pixel electrode connected to the thin film transistor;
a roof layer disposed to be separated from the pixel electrode via a plurality of microcavities on the pixel electrode;
a liquid crystal layer filling the microcavities; and
an encapsulation layer disposed on the roof layer and sealing the microcavities,
wherein the roof layer includes a partition positioned between the plurality of microcavities, and
the partition has a width that decreases with increasing distance from the substrate.

2. The display device of claim 1, wherein
the encapsulation layer is positioned directly on the roof layer.

3. The display device of claim 1, further comprising
a first alignment layer positioned between the pixel electrode and at least one of the microcavities; and
a second alignment layer positioned between the roof layer and at least one of the microcavities, wherein the second alignment layer contacts the roof layer.

4. The display device of claim 1, further comprising
a common electrode overlapping the pixel electrode; and
an insulating layer between the common electrode and the pixel electrode.

5. The display device of claim 1, wherein
the roof layer includes a photosensitive material.

6. The display device of claim 5, wherein
the photosensitive material is formed of a material that is cross-linked by a hardening process.

7. A method for manufacturing a display device comprising:
forming a thin film transistor on a substrate;
forming a pixel electrode connected to the thin film transistor;
forming a photoresist on the pixel electrode;
exposing the photoresist by using a mask;
hardening the exposed photoresist;
exposing the photoresist that is hardened;
developing the photoresist that is exposed to form a roof layer separated from the pixel electrode via the plurality of microcavities;
injecting a liquid crystal material into the microcavities to form a liquid crystal layer; and
forming an encapsulation layer on the roof layer to seal the microcavities.

8. The method of claim 7, wherein
the photoresist is a positive photoresist.

9. The method of claim 8, wherein
the mask is formed of a half-tone mask or a slit mask.

10. The method of claim 9, wherein
the mask includes a transmitting part that transmits substantially all of incident light, a half-transmitting part that partially transmits the incident light, and a non-transmitting part that blocks the incident light.

11. The method of claim 10, wherein the developing comprises:
forming a first portion of the photoresist corresponding to the transmitting part of the mask,
forming the microcavities by removing a lower portion in a second portion of the photoresist corresponding to the half-transmitting part of the mask, and
removing a third portion of the photoresist corresponding to the non-transmitting part of the mask.

12. The method of claim 7, wherein
the photoresist includes a photosensitive material that is cross-linked by the hardening process.

13. The method of claim 12, wherein the hardening comprises:
causing the first portion of the photoresist corresponding to the transmitting part of the mask to be cross-linked, and
causing the upper portion to be cross-linked in the second portion of the photoresist corresponding to the half-transmitting part of the mask.

14. The method of claim 7, wherein
the roof layer includes a partition positioned between the plurality of microcavities, and
the first portion of the photoresist corresponding to the transmitting part of the mask becomes the partition.

15. The method of claim 14, wherein
the partition has a width that decreases with distance from the substrate.

16. The method of claim 7, wherein
the encapsulation layer is positioned directly on the roof layer.

17. The method of claim 7, wherein the hardening is a first-hardening, further comprising
second-hardening the roof layer.

18. The method of claim 17, wherein
the first-hardening is performed through low temperature heat treatment and the second-hardening is performed through high temperature heat treatment.

19. The method of claim 7, further comprising
injecting an aligning agent in the microcavities to form an alignment layer after forming the roof layer, wherein the alignment layer contacts the roof layer.

20. The method of claim 7, further comprising
forming a common electrode overlapping the pixel electrode with the insulating layer between the common electrode and the pixel electrode.
